(19) United States
(12) Patent Application Publication
(10) Pub. No.: US 2015/0264530 A1
(43) Pub. Date: Sep. 17, 2015

(54) ACCESS POINT INITIATED TIME-OF-FLIGHT POSITIONING

(71) Applicants: GABY PRECHNER, RISHON LEZION (IL); KOBI KOPELMAN, PETACH TIKVA (IL); IDAN GALON, NES TZIONA (IL); ERAN REUVENI, GIVATAIM (IL)

(72) Inventors: GABY PRECHNER, RISHON LEZION (IL); KOBI KOPELMAN, PETACH TIKVA (IL); IDAN GALON, NES TZIONA (IL); ERAN REUVENI, GIVATAIM (IL)

(21) Appl. No.: 14/205,888

(22) Filed: Mar. 12, 2014

(51) Int. Cl. H04W 4/02

(52) U.S. Cl. CPC H04W 4/025; H04W 4/04

(57) ABSTRACT

Embodiments of a system and method for Access Point (AP) initiated time-of-flight positioning in a Wireless Network are generally described herein. A precise scalable network initiated Time-of-Flight (ToF) solution for indoor positioning and navigation is provided for environments where global-navigation-satellite-systems signals are not available. ToF between an initiating AP and a responding device is measured and converted into distance by dividing the measured time by two and multiplying it by the speed of light. The AP, rather than the client, fully controls the timing and management of the overall indoor location procedure. The Fine Timing Measurement portion of the Access Point Initiated ToF Positioning protocol is a symmetric protocol such that measurement of the ToF is readily switchable between the client and the AP. In some embodiments, an initiating Access Point Fine Timing Request message triggers a ToF measurement and location calculation message exchange between the initiating AP and responding device.

### TECHNICAL FIELD

Embodiments pertain to wireless networks. Some embodiments relate to wireless networks that operate in accordance with one of the IEEE 802.11 standards including the IEEE 802.11-2012 standards. Some embodiments relate to time-of-flight (ToF) positioning. Some embodiments relate to location determination. Some embodiments relate to indoor navigation.

### BACKGROUND

Outdoor navigation and positioning has been widely deployed following the development of various global navigation-satellite-systems (GNSS) as well as various cellular systems. Indoor navigation and positioning differs from outdoor navigation and positioning because the indoor environment does not enable the reception of location signals from satellites or cellular base stations as accurately as in the outdoor environment. As a result, accurate and real-time indoor navigation and positioning are difficult to achieve.

Conventional indoor navigation and positioning methods, i.e. “fingerprinting”, “site-mapping” etc., calculate location by measuring received signal strength from an Access Point (AP). A handheld device initiates a location calculation by measuring the strength of a received signal and determines its position by figuring its distance from the location of a router or other access point transmitting the received signal. Unfortunately, these methods are inaccurate due to large variances in received signal strength. Fluctuations in received signal strength produce an approximately 20 meter radius of error. Another drawback of conventional indoor location methods is the inability of the network to initiate and significantly control the timing and management for location of a handheld device. Thus, there is a need for accurate indoor ToF navigation and positioning methods that can be initiated and controlled by a network AP and do not require client initiation, interruption, intervention, inconvenience, or responses.

### BRIEF DESCRIPTION OF THE DRAWINGS

FIG. 1 is a network diagram illustrating an exemplary network environment suitable for Access Point Initiated Time-of-Flight (ToF) Positioning, according to some example embodiments;

FIG. 2 shows a block diagram of a high level overview flow chart of Access Point Initiated ToF Positioning, according to some example embodiments;

FIG. 3 illustrates a procedure for basic time-of-flight (ToF) calculation, in accordance with some exemplary embodiments;

FIG. 4 illustrates an updated procedure for time-of-flight (ToF) positioning, in accordance with some exemplary embodiments;

FIG. 5 illustrates a procedure for Access Point Initiated time-of-flight (ToF) Positioning, according to some exemplary embodiments; and

FIG. 6 is a functional diagram of an exemplary communication station in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments.

The terms “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, access terminal, or other personal communication system (PCS) device. The device may be either mobile or stationary.

The term “access point” as used herein may be a fixed station. An access point may also be referred to as an access node, a base station or some other similar terminology known in the art. An access terminal may also be called a mobile station, a user equipment (UE), a wireless communication device or some other similar terminology known in the art.

A precise scalable Time-of-Flight (ToF) solution for indoor positioning and navigation is provided for environments where global-navigation-satellite-systems (GNSS, GPS, GLONASS and GALILEO) signals are not available. Time-of-Flight (ToF) is defined as the overall time a signal requires to propagate from the user to an Access Point (AP) and back to the user. A measured ToF value is converted into distance by dividing the measured time by two and multiplying it by the speed of light.

In many instances and applications, a network requires the client location, preferably without client initiation, interruption, intervention, inconvenience, or responses. An accurate method for indoor location where the AP is the initiator of the protocol is disclosed. The present network initiated location methods do not require the client to perform any client initiated ToF procedures and/or reporting back to the AP. The AP, rather than the client, fully controls the timing and management of the overall indoor location procedure, making the procedure more convenient and power efficient for the client. The Fine Timing Measurement portion of the Access Point Initiated ToF Positioning protocol is a symmetric protocol such that initiation of the ToF measurement is readily switchable between the client and the AP.

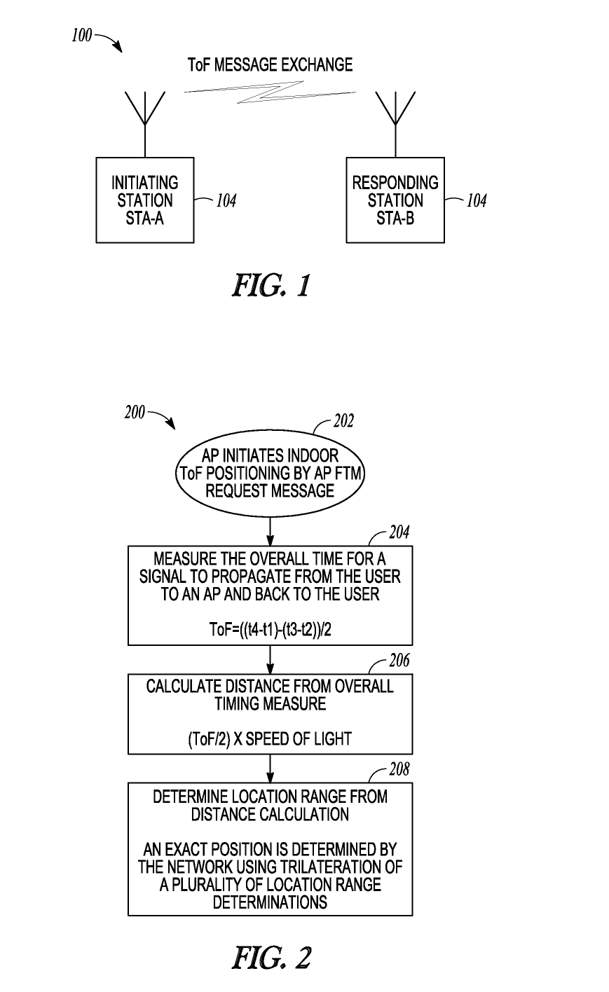

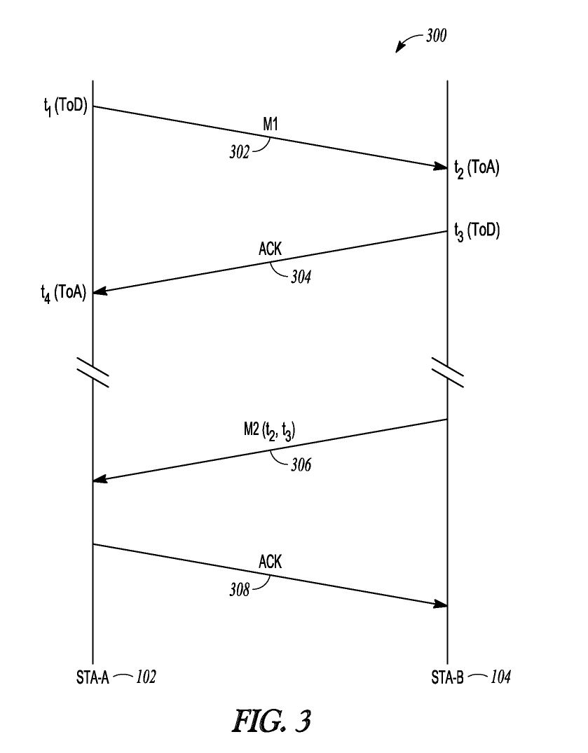

FIG. 1 illustrates various network elements of a wireless network in accordance with some embodiments. Wireless network 100 includes a plurality of communication stations (STAs) and one or more access points (APs) which may communicate in accordance with IEEE 802.11 communication techniques. The communication stations may be mobile devices that are non-stationary and do not have fixed locations. The one or more access points may be stationary and have fixed locations. The stations may include an initiating station STA-A 102 and one or more responding station STA-B 104. The initiating station 102 may be a communication station that initiates ToF positioning with the responding station 104 to determine its location. The ToF positioning procedure may include the exchange of messages including the exchange of messages, as described in more detail below in FIGS. 3-5.

In some embodiments, the initiating station 102 may be a positioning station and may determine its location relative to one or more responding stations (e.g., cooperating stations and/or one or more access points). The cooperating stations may be either IEEE 802.11 configured communication stations (STAs) or APs. In other embodiments, the initiating station 102 may determine its location in geo-coordinates. In some embodiments, the responding station may be able to determine its location either in relative or in geo-coordinates.

FIG. 2 is a flowchart illustrating operations in performing a method 200 of Access Point Initiated ToF Positioning, according to some example embodiments. Operations in the method 200 may be performed by the initiating station STA-A 102 and/or responding station STA-B described above with respect to FIG. 1. As shown in FIG. 2, the method 200 includes operations 202, 204, 206, and 208.

Beginning in operation 202, the initiating station STA-A 102 initiates indoor ToF positioning operations with responding station STA-B 104 by sending an AP FTM Request message to responding station STA-B 104. Control flow proceeds to operation 204.

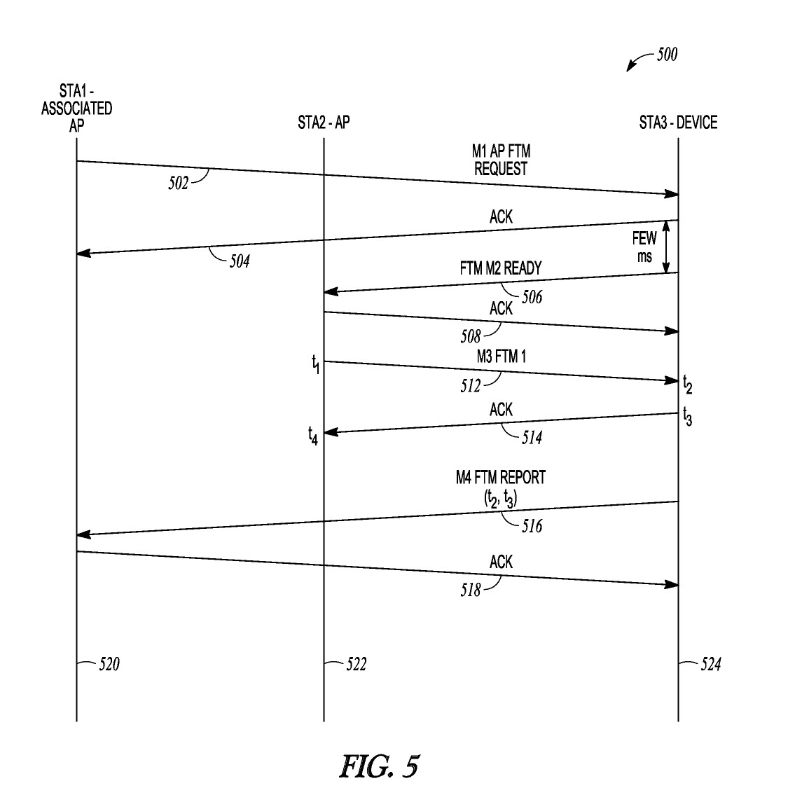

In operation 204, ToF is measured between the initiating station STA-A 102 and responding station STA-B 104. ToF measurement is performed using timers t1−t4 wherein, ToF, ((t4−t1)−(t3−t2))/2. Messaging protocols for timing measurements are detailed in FIG. 5 below. Control flow proceeds to operation 206.

In operation 206, the distance from initiating station STA-A 102 and responding station STA-B is calculated from the ToF measurement. The distance is calculated by dividing the measured ToF by two and multiplying it by the speed of light. Control flow proceeds to operation 208.

In operation 208, a location range of the responding station STA-B 104 is determined by the network and/or responding station STA-B from its calculated distance away from initiating station STA-A 102. In other words, the location range is a circle having a radius equal to the calculated distance from the AP. An exact position is determined by the network and/or responding station STA-B using trilateration of a plurality of location range determinations.

FIG. 3 illustrates a procedure for basic time-of-flight (ToF) calculation portion of Access Point Initiated ToF Positioning, in accordance with some exemplary embodiments. As illustrated in FIG. 3, initiating station STA-A 102 may be arranged to transmit a message M1 302 carrying a management frame to responding station STA-B 104, which may respond with an ACK 304. M1 302 may be a timing measurement action frame. The timing measurement action frame may be a unicast management frame. T1, the M1 time of departure (ToD) from the initiating station STA-A 102 and t2, the time of arrival (ToA) of M1 at the responding station STA-B 104, are saved.

The responding station STA-B 104 may be arranged to transmit a message M2 306 at ToD, t3, carrying a management frame to initiating station STA-A 102, which may respond with an ACK 308. M2 306 may be a timing measurement action frame. The timing measurement action frame may be a unicast management frame. M2 306 may return saved time value t2 and a ToD of ACK 304, t3, time value to initiating station STA-A 102.

All time of departures and time of arrivals, t1−t4, are saved at initiating STA-A 102. Initiating station STA-A 102 computes the ToF by the following equation:

ToF=((t4−t1)−(t3−t2))/2 (Equation 1)

In some embodiments, the messages M1 302 and M2 306 may be a timing measurement action frame in accordance with 802.11(v). The message M1 302 may refer to an M1 frame and the message M2 306 may refer to an M2 frame. In some embodiments, the message M1 302 may be used to initiate ToF positioning with another station.

In some embodiments, the message M1 may be a first timing measurement action frame and the message M2 may be a second timing measurement action frame. In some embodiments, the timing measurement action frames may be timing measurement frames. In some embodiments, a Media Access Control (MAC) Sublayer Management Entity (MLME) constructs the timing measurement frames.

In some embodiments, the timing measurement information may be a t2 value and a t3 value (i.e., two values) or a t3−t2 value (i.e., a single difference value). In these embodiments, the initiating station may be arranged to parse the structure of the message M2 306. By parsing the structure of message M2 306, the initiating station STA-A 102 can determine whether the message M2 306 contains either a t2 and a t3 value (i.e., two values), or a t3−t2 value (i.e., a single difference value). In some of these embodiments, the message M2 306 may include different elements or employ sub-element coding to allow the initiation station to parse the structure of message M2 306.

In some embodiments, t2 may be a time-stamp against a local clock associated with the arrival of message M1 302 at the responding station STA-B 104, and t3 may be a time-stamp against the local clock associated with transmission of message M2 306 by the responding station STA-B 104 (i.e., measured against the same clock as t2). In some embodiments, t1 may be a time-stamp against a local clock associated with the transmission of message M1 302 by the initiating station STA-A 102 and t4 may be a time-stamp against the local clock associated with receipt of the acknowledgement frame 304 that acknowledges receipt of the message M1 (i.e., measured against the same clock as t1).

In some embodiments, the t2 value is the ToA of message M1 302 at the responding station STA-B 104, and the t3 value is time that the ACK frame 304 is sent by the responding station STA-B 104. The inclusion of both t2 and t3 values may be more optimal as it may allow a particular and more straightforward way to calibrate for difference in the clock rates at the two stations for increased ToF accuracy. Furthermore, inclusion of a single value (t3−t2) may allow the relative timing drift between the recipient and the responding stations to be tracked for increased ToF accuracy.

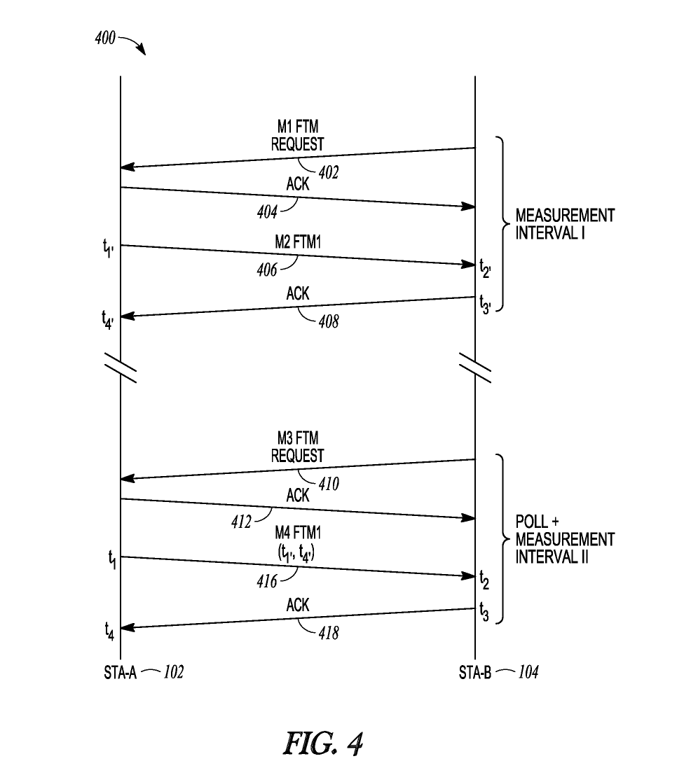

FIG. 4 illustrates an updated procedure for time-of-flight (ToF) positioning 400, in accordance with some other exemplary embodiments having finer timing measurement resolution. As illustrated in FIG. 4, responding station STA-A 104 may be arranged to transmit a message M1 402 carrying an Fine Timing (FTM) request message to initiating station STA-A (i.e. the AP) 102, which may respond with an ACK 404.

Initiating station STA-A 102 may start the timing measurements immediately by sending a Fine Timing Measurement 1 (FTM1) message, M2 406, at ToD time t1′ to responding station STA-A 104 arriving at ToA time t2′. Responding station STA-A 104 may respond with an ACK 408 at ToD time t3′, which arrives at initiating station STA-A 104 at ToA time t4′. T1′ the ToD of M2 406 from the initiating station STA-A 102 and t4′ the time of arrival (ToA) of ACK 408 at initiating station STA-A 102, are saved by initiating station STA-A 102. This message exchange produces Measurement Interval I. In alternative embodiments, responding station STA-A 104 may answer with a window of availability such that the measurement itself may occur in a later stage.

Responding station STA-A 104 may be arranged to transmit another FTM Request message M3 410 carrying a second management frame to initiating station STA-A 102, which may respond with an ACK 412. FTM Request message M3 410 may initiate another Fine Timing Measurement by initiating station STA-A 102. initiating station STA-A 102 may start a second fine timing measurement immediately by sending an FTM1 message, M4 416, at ToD time t1 reporting saved t1′ and t4′ to responding station STA-A 104, which may respond with an ACK 418 at ToD time t3, arriving at initiating station STA-A 104 at ToA time t4. This message exchange produces Measurement Interval II. Initiating station STA-A 102 computes the final ToF from the timing values t1−t4.

In some embodiments, FTM request messages M1 402 and M3 410 may be a fine-timing measurement action frame in accordance with 802.11REVmc. The FTM request messages M1 402 and M3 410 may refer to an M1 and M3 frame respectively. The FTM1 messages M2 406 and M4 416 may refer to an M2 and M4 frame respectively. In some embodiments, the message M1 402 may be used to initiate ToF positioning with another station.

In some embodiments, the message M2 406 may be a first timing measurement action frame and the message M4 414 may be a second timing measurement action frame. In some embodiments, the timing measurement action frames may be timing measurement frames. In some embodiments, a Media Access Control (MAC) Sublayer Management Entity (MLME) constructs the timing measurement frames.

In some embodiments, the timing measurement information may be a t1′ value and a t4′ value (i.e., two values) or a t4′−t1′ value (i.e., a single difference value). In these embodiments, the initiating station STA-A 102 may be arranged to parse the structure of the message M4 416. By parsing the structure of message M4 416, the initiating station STA-A 102 can determine whether the message M4 416 contains either a t1′ value and a t4′ value (i.e., two values) or a t4′−t1′ value (i.e., a single difference value). In some of these embodiments, the message M4 416 may include different elements or employ sub-element coding to allow the initiation station to parse the structure of message M4 416.

In some embodiments, t2 may be a time-stamp against a local clock associated with the arrival of FTM1 message M4 416 at the responding station STA-B 104, and t3 may be a time-stamp against the local clock associated with transmission of the ACK frame 418 sent by the responding station STA-B 104. In some embodiments, t1′ may be a time-stamp against a local clock associated with the transmission of message FTM1 406 by the initiating station STA-A 102 and t4 may be a time-stamp against the local clock associated with receipt of the acknowledgement frame 408 that acknowledges receipt of the FTM1 message M2 406 (i.e., measured against the same clock as t1′.

In some embodiments, the t2 value is the time that the FTM1 message M4 416 arrived at the responding station STA-B 104, and the t3 value is time that the ACK frame 418 is sent by the responding station STA-B 104. The inclusion of both t1′ value and t4′ value in second FTM1 message 416 may be more optimal as it may allow a particular and more straightforward way to calibrate for difference in the clock rates at the two stations for increased ToF accuracy. Furthermore, inclusion of a single value (t4′−t1′) may allow the relative timing drift between the recipient and the responding stations to be tracked for increased ToF accuracy.

FIG. 5 illustrates a procedure for Access Point Initiated ToF Positioning 500, according to some exemplary embodiments. Access Point Initiated ToF Positioning overcomes numerous disadvantages of simply reversing a client initiated protocol, such as the need to implement a new message flow both in the AP and the client, difficulty implementing necessary functionality for resource availability in the client, and excessive time non-associated AP(s) STA-2 AP 522 are off channel.

Access Point Initiated ToF Positioning minimizes the time an unassociated AP is off channel by the associated AP performing the negotiation phase and resulting reporting stage, enabling improved use of AP resources and supporting more users. The measurement phase of Access Point Initiated ToF Positioning is nearly identical to the basic protocol, simplifying implementation, testing and certification. The Access Point Initiated ToF Positioning protocol can be extended such that the AP FTM Request contains multiple APs, enabling a full network initiated protocol.

The Access Point Initiated ToF Positioning protocol causes an associated AP to request positioning from a device by issuing an AP FTM Request message, triggering the device to perform an FTM procedure nearly identical to the basic protocols presented in FIGS. 3 and 4. Rather than sending a basic protocol FTM request message to the AP, the client sends an FTM Ready message. The FTM ready message causes the same measurement as the FTM Request message of the basic protocols. The measurement stage (FTM1 and ACK) is then performed. All of the procedures from FTM ready to the ACK following the FTM1 are performed with the AP seeking positioning of the client allowing unassociated APs to service more users by minimizing the time an unassociated AP is off channel. The Access Point Initiated ToF Positioning method then causes reporting of the timer values, t1−t4, to the associated AP.

As illustrated in FIG. 5, Associated AP, STA1 520, may be arranged to transmit an AP FTM Request message M1 502 carrying a management frame to responding device STA3 524, which may respond with an ACK 504. M1 502 may be a timing measurement action frame. The timing measurement action frame may be a unicast management frame.

The responding device STA3 524 may be arranged to then transmit an FTM Ready message M2 506 to associated AP STA1 520 or unassociated AP STA2 522, which may respond with an ACK 508.

STA2-AP 522 (or STA1 520) may be arranged to transmit an FTM1 message M3 512 at ToD t1 carrying a management frame to responding device STA3 524, which may receive the message at ToA t2 and respond with an ACK frame 514 at ToD t3, arriving at STA2-AP at ToA t4. FTM1 message M3 512 may be a timing measurement action frame. The timing measurement action frame may be a unicast management frame. T2, the time of arrival (ToA) of FTM1 message M3 512 at the responding device STA3 512 and t3 the time of departure (ToD) of its ACK 514 from the responding station STA3 524 and are saved by responding device STA3 524.

The responding device STA3 524 may be arranged to transmit an FTM report message M4 516 carrying a management frame to Associated AP STA1 520, which may respond with an ACK frame 518. FTM Report Message M4 516 may be a timing measurement action frame. The timing measurement action frame may be a unicast management frame. M4 516 may return saved time values t2 and t3 to initiating associated STA1 AP 520. All time of departures and time of arrivals, t1−t4, are saved. Initiating Associated STA1 AP 520 computes the final ToF by the following equation:

ToF=((t4−t1)−(t3−t2))/2 (Equation 1)

In some embodiments, the messages M1 302 and M2 306 may be a timing measurement action frame in accordance with 802.11(v)), while in some other embodiments that provide finer measurement resolution; the message M1 202 may be a fine-timing measurement action frame in accordance with 802.11REVmc. The message M3 512 may refer to an M3 frame and the message M4 516 may refer to an M4 frame. In some embodiments, the message M1 502 may be used to initiate ToF positioning with another station.

In some embodiments, the message M3 may be a first timing measurement action frame and the message M4 may be a second timing measurement action frame. In some embodiments, the timing measurement action frames may be timing measurement frames. In some embodiments, a Media Access Control (MAC) Sublayer Management Entity (MLME) constructs the timing measurement frames.

In some embodiments, the timing measurement information may be a t2 value and a t3 value (i.e., two values) or a t3−t2 value (i.e., a single difference value). In these embodiments, the initiating station STA1 520 may be arranged to parse the structure of the message M4 516. By parsing the structure of message M4 516, the initiating station STA1 520 can determine whether the message M4 516 contains either a t2 value and a t3 value (i.e., two values) or a t3−t2 value (i.e., a single difference value). In some of these embodiments, the message M4 516 may include different elements or employ sub-element coding to allow the initiation station STA1-AP 502 to parse the structure of message M4 516.

In some embodiments, t2 may be a time-stamp against a local clock associated with the arrival of message M3 at the responding device STA3 524, and t3 may be a time-stamp against the local clock associated with transmission of ACK message 514 by the responding device STA3 524 (i.e., measured against the same clock as t2). In some embodiments, t1 may be a time-stamp against a local clock associated with the transmission of message FTM1 M3 512 by the non-associated access point STA2 522 and t4 may be a time-stamp against the local clock associated with receipt of the acknowledgement frame that acknowledges receipt of the message M3 (i.e., measured against the same clock as t1).

In some embodiments, the t2 value is the time that the FTM1 message M3 512 arrived at the responding device STA3 524, and the t3 value is time that the ACK frame 514 is sent by the responding device STA3 524. The inclusion of both t2 value and t3 value may be more optimal as it may allow a particular and more straightforward way to calibrate for difference in the clock rates at the two stations for increased ToF accuracy. Furthermore, inclusion of a single value (t3−t2) may allow the relative timing drift between the recipient and the responding stations to be tracked for increased ToF accuracy.

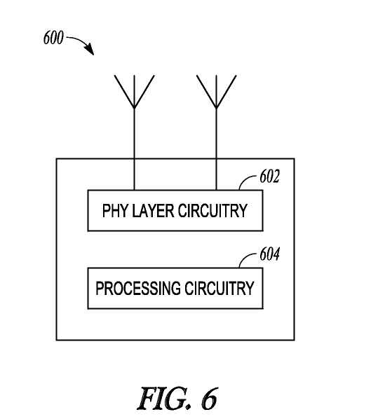

FIG. 6 is a functional diagram of a communication station in accordance with some embodiments. Communication station 600 may be suitable for use as either a responding station, such as responding station 104 (FIG. 1), or an initiating station, such as initiating station 102 (FIG. 1). Communication station 600 may include physical layer circuitry 602 for transmitting and receiving messages (e.g., frames) as described herein and processing circuitry 604 for performing the various operations described herein.

In some embodiments, the physical layer circuitry 602 and the processing circuitry 604 may be configured to transmit and receive messages M1-M4 (FIG. 5) carrying time management frames as detailed above.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the communication station 600 may include one or more antennas. The antennas may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although communication station 600 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device.

In one example, a method for time-of-flight (ToF) positioning performed by an Access Point initiating station comprises transmitting, by the Access Point (AP), a message M1 carrying an AP Fine Timing Measurement (FTM) Request to a responding station, the AP FTM Request message directing the responding station to transmit an FTM Ready Message M2 indicating that responding station is ready to perform a Fine Timing measurement, receiving, at the AP from the responding station, the FTM Ready message M2, causing the initiating station to prepare an FTM1 message M3 for transmission to the responding station, transmitting, by the AP, the FTM1 message M3 to the responding station, directing the responding station to transmit an FTM report message M4 to the AP, and receiving, at the AP from the responding station, the FTM Report message M4, the FTM Report message M4 carrying timing information for calculating ToF positioning of the responding device.

In another example, a communication station is arranged to perform time-of-flight (ToF) positioning, the station comprising physical layer circuitry and processing elements arranged to transmit, by the Access Point (AP), a message M1 carrying an AP Fine Timing Measurement (FTM) Request to a responding station, the AP FTM Request message directing the responding station to transmit an FTM Ready Message M2 indicating that responding station is ready to perform a Fine Timing measurement, receive, at the AP from the responding station, the FTM Ready message M2, causing the initiating station to prepare an FTM1 message M3 for transmission to the responding station, transmit, by the AP, the FTM1 message M3 to the responding station, directing the responding station to transmit an FTM report message M4 to the AP, and receive, at the AP from the responding station, the FTM Report message M4, the FTM Report message M4 carrying timing information for calculating ToF positioning of the responding device.

In another example, a non-transitory computer-readable storage medium that stores instructions for execution by one or more processors to perform operations comprises transmitting, by the Access Point (AP), a message M1 carrying an AP Fine Timing Measurement (FTM) Request to a responding station, the AP FTM Request message directing the responding station to transmit an FTM Ready Message M2 indicating that responding station is ready to perform a Fine Timing, measurement receiving, at the AP from the responding station, the FTM Ready message M2, causing the initiating station to prepare an FTM1 message M3 for transmission to the responding station, transmitting, by the AP, the FTM1 message M3 to the responding station, directing the responding station to transmit an FTM report message M4 to the AP; and receiving, at the AP from the responding station, the FTM Report message M4, the FTM Report message M4 carrying timing information for calculating ToF positioning of the responding device.

In one example, Time of Departure (ToD) time value t1 for the message M3 and a Time of Arrival (ToA) time value t4 for a corresponding received Acknowledgement frame (ACK) are saved by the initiating station.

In another example, a Time of Arrival (ToA) time value t2 for the message M3 and Time of Departure (ToD) time value t3 for a corresponding received Acknowledgement frame (ACK), or a difference value of t3−t2, are received in an FTM Report message M4 by the AP.

In another example, Time-of-Flight (TOF) is calculated as ((t4−t1)−(t3−t2))/2, and a distance from an initiating station is calculated as (ToF/2)×speed of light.

In another example, a location range of the responding device is determined by the AP, according to a distance from the initiating station derived from a ToF calculation, and an exact position is determined by using trilateration of a plurality of location range determinations.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method for time-of-flight (ToF) positioning performed by an Access Point initiating station, the method comprising:
transmitting, by the Access Point (AP) initiating station, a message M1 carrying an AP Fine Timing Measurement (FTM) Request to a responding station, the AP FTM Request message directing the responding station to transmit an FTM Ready Message M2 indicating that the responding station is ready to perform a FTM;
receiving, at the AP initiating station from the responding station, the FTM Ready message M2, causing the AP initiating station to prepare an FTM1 message M3 for transmission to the responding station;
transmitting, by the AP initiating station, the FTM1 message M3 to the responding station, directing the responding station to transmit an FTM report message M4 to the AP initiating station; and
receiving, at the AP initiating station from the responding station, the FTM Report message M4, the FTM Report message M4 carrying timing information for calculating ToF positioning of the responding device.

2. The method of claim 1 further comprising saving, at the AP initiating station, a Time of Departure (ToD) time value t1 for the message M3 and a Time of Arrival (ToA) time value t4 for a corresponding received Acknowledgement frame (ACK).

3. The method of claim 1 further comprising receiving, by the AP initiating station, a Time of Arrival (ToA) time value t2 for the message M3 and Time of Departure (ToD) time value t3 for a corresponding received Acknowledgement frame (ACK), or a difference value of t3−t2, in an FTM Report message M4.

4. The method of claim 1 further comprising calculating, by the AP initiating station, Time-of-Flight (TOF) as ((t4−t1)−(t3−t2))/2, and a distance from an AP initiating station as (ToF/2)×speed of light.

5. The method of claim 1 further comprising determining, by the AP initiating station and/or a responding station, a location range of the responding device according to a distance from the AP initiating station derived from a ToF calculation; and determining an exact position of the responding device by using trilateration of a plurality of location range determinations.

6. A communication station arranged to perform time-of-flight (ToF) positioning, the communication station comprising physical layer circuitry and processing elements to:
transmit, a message M1 carrying an Access Point (AP) Fine Timing Measurement (FTM) Request to a responding station, the AP FTM Request message directing the responding station to transmit an FTM Ready message M2 indicating that responding station is ready to perform a Fine Timing Measurement;
receive, from the responding station, the FTM Ready message M2, causing the communication station to prepare an FTM1 message M3 for transmission to the responding station;
transmit the FTM1 message M3 to the responding station, directing the responding station to transmit an FTM report message M4 to the communication station; and
receive, from the responding station, the FTM Report message M4, the FTM Report message M4 carrying timing information for calculating ToF positioning of the responding device.

7. The communication station of claim 6 further arranged to save a Time of Departure (ToD) time value t1 for the message M3 and a Time of Arrival (ToA) time value t4 for a corresponding received Acknowledgement frame (ACK).

8. The communication station of claim 6 further arranged to receive a Time of Arrival (ToA) time value t2 for the message M3 and Time of Departure (ToD) time value t3 for a corresponding received Acknowledgement frame (ACK), or a difference value of t3−t2, in an FTM Report message M4 by the AP.

9. The communication station of claim 6 further arranged to calculate Time-of-Flight (TOF) as ((t4−t1)−(t3−t2))/2, and to calculate a distance from an initiating station as (ToF/2)×speed of light.

10. The communication station of claim 6 further arranged to determine a location range of the responding device according to a distance from the communication station derived from a ToF calculation; and determine an exact position of the responding device by using trilateration of a plurality of location range determinations.

11. The communication station of claim 6 further arranged to comprise physical layer circuitry and associated antenna(s) capable of sending and receiving wireless communications messages M1-M4.

12. The communication station of claim 6 further arranged to comprise processing circuitry for:
transmitting, by the Access Point (AP) initiating station, a message M1 carrying an AP Fine Timing Measurement (FTM) Request to a responding station, the AP FTM Request message directing the responding station to transmit an FTM Ready Message M2 indicating that the responding station is ready to perform a FTM;
receiving, at the AP initiating station from the responding station, the FTM Ready message M2, causing the AP initiating station to prepare an FTM1 message M3 for transmission to the responding station;
transmitting, by the AP initiating station, the FTM1 message M3 to the responding station, directing the responding station to transmit an FTM report message M4 to the AP initiating station; and
receiving, at the AP initiating station from the responding station, the FTM Report message M4, the FTM Report message M4 carrying timing information for calculating ToF positioning of the responding device.

13. A non-transitory computer-readable storage medium that stores instructions for execution by one or more processors to perform operations for time-of-flight (ToF) positioning performed by an Access Point initiating station, the method comprising:
transmitting, by the Access Point (AP) initiating station, a message M1 carrying an AP Fine Timing Measurement (FTM) Request to a responding station, the AP FTM Request message directing the responding station to transmit an FTM Ready Message M2 indicating that the responding station is ready to perform a FTM;
receiving, at the AP initiating station from the responding station, the FTM Ready message M2, causing the AP initiating station to prepare an FTM1 message M3 for transmission to the responding station;
transmitting, by the AP initiating station, the FTM1 message M3 to the responding station, directing the responding station to transmit an FTM report message M4 to the AP initiating station; and
receiving, at the AP initiating station from the responding station, the FTM Report message M4, the FTM Report message M4 carrying timing information for calculating ToF positioning of the responding device.

14. The non-transitory computer-readable storage medium of claim 13 further comprising saving, at the AP initiating station, a Time of Departure (ToD) time value t1 for the message M3 and a Time of Arrival (ToA) time value t4 for a corresponding received Acknowledgement frame (ACK).

15. The non-transitory computer-readable storage medium of claim 13 further comprising receiving, by the AP initiating station, a Time of Arrival (ToA) time value t2 for the message M3 and Time of Departure (ToD) time value t3 for a corresponding received Acknowledgement frame (ACK), or a difference value of t3−t2, in an FTM Report message M4.

16. The non-transitory computer-readable storage medium of claim 13 further comprising calculating, by the AP initiating station, Time-of-Flight (TOF) as ((t4−t1)−(t3−t2))/2, and a distance from an AP initiating station as (ToF/2)×speed of light.

17. The non-transitory computer-readable storage medium of claim 13 further comprising determining, by the AP initiating station and/or a responding station, a location range of the responding device according to a distance from the AP initiating station derived from a ToF calculation; and determining an exact position of the responding device by using trilateration of a plurality of location range determinations.
